(19) United States
(12) Patent Application Publication
(10) Pub. No.: US 2026/0220236 A1
(43) Pub. Date: Jul. 30, 2026

(54) USER AUTHENTICATION ON TOUCH-SCREEN SYSTEM

(71) Applicant: Microsoft Technology Licensing, LLC, Redmond, WA (US)

(72) Inventors: Roei Shlomo MENASHOF, Netanya (IL); Oren ISTRIN, Tel Aviv (IL); Netanel HADAD, Lod (IL)

(73) Assignee: Microsoft Technology Licensing, LLC, Redmond, WA (US)

(21) Appl. No.: 19/040,255

(22) Filed: Jan. 29, 2025

(51) Int. Cl. G06F 21/32; G06F 3/041; G06F 3/044; G06F 3/16

(52) U.S. Cl. CPC G06F 21/32; G06F 3/04162; G06F 3/0441; G06F 3/0442; G06F 3/167

(57) ABSTRACT

A method for controlling user access to a touch-screen system comprises: (a) receiving an uplink signal from a key device and extracting corresponding uplink data from the uplink signal; (b) providing challenge data in response to the uplink data and transmitting a corresponding challenge signal to the key device, where the challenge signal is transmitted by a touch-sensor transmitter also configured to transmit a synchronization signal to an active pen; (c) receiving a downlink signal from the key device and extracting corresponding downlink data from the downlink signal, where the uplink and downlink signals are received by a touch-sensor receiver also configured to receive sensory signal from the active pen; and (d) forbidding a user from accessing the touch-screen system unless the downlink data authenticates the user and signal of pre-determined signal strength continues to be received from the key device.

### BACKGROUND

Many computer systems in use today are equipped with capacitive touch sensors. Often the capacitive touch sensor is arranged over an electronic display, which may present a graphical user interface. By virtue of the touch sensor, the graphical user interface is capable of receiving input to the computer system as well as displaying an output. Frequently a capacitive touch sensor is configured to register touch from an active pen, or stylus, in lieu of the user’s fingertip. In some capacitive touch sensors, timing and sensory data is exchanged between touch-sensor and active-pen logic via modulated, radio-frequency (RF) carrier waves.

### SUMMARY

One aspect of this disclosure relates to a method for controlling user access to a touch-screen system. The method comprises: (a) receiving an uplink signal from a key device and extracting corresponding uplink data from the uplink signal; (b) providing challenge data in response to the uplink data and transmitting a corresponding challenge signal to the key device, wherein the challenge signal is transmitted by a touch-sensor transmitter also configured to transmit a synchronization signal to an active pen; (c) receiving a downlink signal from the key device and extracting corresponding downlink data from the downlink signal, wherein the uplink and downlink signals are received by a touch-sensor receiver also configured to receive sensory signal from the active pen; and (d) forbidding a user from accessing the touch-screen system unless the downlink data authenticates the user and signal of pre-determined signal strength continues to be received from the key device.

Another aspect of this disclosure relates to a touch-screen system comprising access logic, a touch-sensor receiver, and a touch-sensor transmitter. The touch-sensor receiver is configured to receive a modulated sensory signal from an active pen, receive an uplink signal from a key device, extract corresponding uplink data from the uplink signal, receive a downlink signal from the key device, and extract corresponding downlink data from the downlink signal. The touch-sensor transmitter is configured to transmit a synchronization signal to the active pen, receive challenge data from the access logic, and transmit corresponding challenge signal to the key device. The access logic is configured to control user access to the touch-screen system, to provide the challenge data in response to the uplink data, and to forbid a user from accessing the touch-screen system unless the downlink data authenticates the user and the touch-sensor receiver continues to receive signal of pre-determined signal strength from the key device.

This Summary is provided in order to introduce in simplified form a selection of concepts that are further described in the Detailed Description. This Summary is not intended to identify key features or essential features of the claimed subject matter, nor is it intended to be used to limit the scope of the claimed subject matter. The claimed subject matter is not limited to implementations that solve any disadvantages noted in any part of this disclosure.

### BRIEF DESCRIPTION OF THE DRAWINGS

FIG. 1 shows aspects of an example environment wherein a user seeks access to a computer system.

FIG. 2 shows aspects of an example key device and touch-screen system.

FIGS. 3 and 4 show aspects of an example touch-screen system.

FIG. 5 shows aspects of another example touch-screen system.

FIG. 6 shows aspects of an example capacitive touch sensor of a touch-screen system.

FIG. 7 shows aspects of the example capacitive touch sensor of FIG. 6 and associated touch-sensor logic.

FIG. 8 shows aspects of an example active pen configured to furnish input to a touch-screen system.

FIG. 9 shows aspects of an example method for controlling user access to a touch-screen system.

FIG. 10 shows aspects of an example computer system.

### DETAILED DESCRIPTION

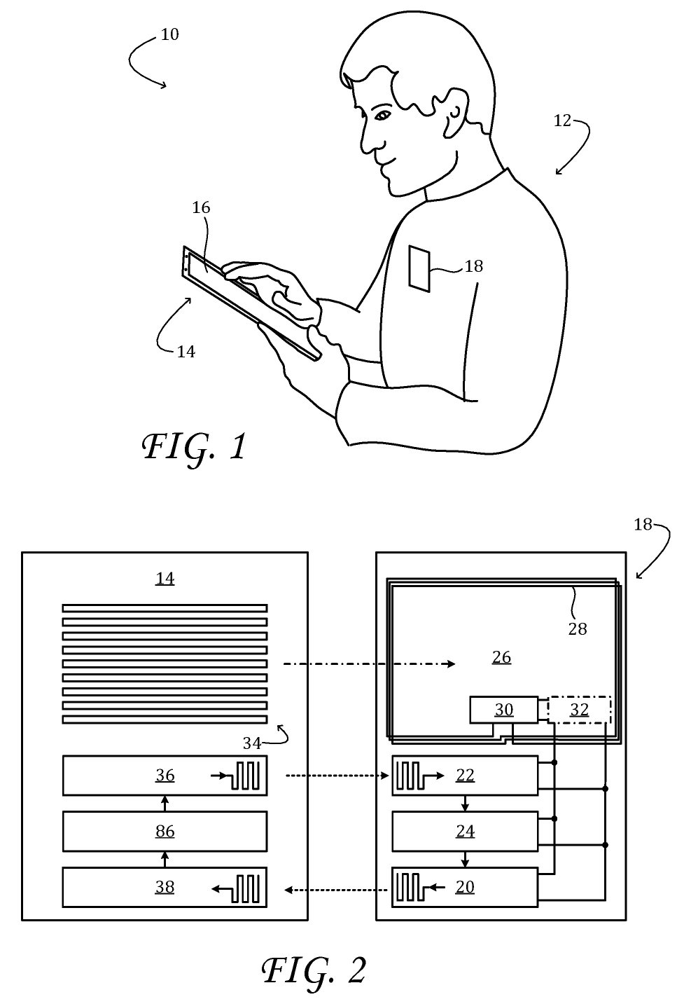

FIG. 1 shows aspects of an example environment 10, wherein at least one user 12 seeks access to a computer system 14. The environment may be a work or academic environment, a home, retail or service environment, or virtually any other kind of environment. The computer system shown in FIG. 1 is a tablet computer system, but that aspect is by no means necessary. In other examples, the computer system may be a laptop computer system, a smartphone or game system, or a control panel of an electronic or mechanical system, such as a kiosk, elevator, or a sound or navigation system of an automobile. These and other kinds of computer systems are all equally envisaged.

Computer system 14 of FIG. 1 includes a transparent, capacitive touch sensor 16 arranged over an electronic display. Generally speaking, a computer system equipped with a touch sensor may be referred to as a ‘touch-screen system’ whether or not the touch sensor is transparent or arranged over an electronic display. As described in greater detail herein, the touch sensor may be configured to receive user input in the form of finger touch and/or the touch of an active pen.

In some examples and scenarios, access to computer system 14, or to one or more functions thereof, may be subject to user authentication. In comparative examples, entry of a passcode via a UI of the computer system may be used to authenticate the user. In some environments, however, passcode entry is an imperfect user-authentication solution. Some users find passcodes difficult to remember, especially passcodes subject to robustness and expiry requirements. In addition, passcode authentication does not easily address the scenario, not uncommon in workgroups, in which an authenticated user walks away from a computer system while still logged in, and a non-authenticated user begins working at the same computer system.

To address these issues and provide further advantages, user 12 in FIG. 1 has on his person a key device 18, which facilitates user authentication on computer system 14. The physical form of the key device is not particularly limited. In some examples, the key device may take the form of a card, name tag, or badge. The key device may be substantially flat in some examples, having a thickness of three millimeters or less. The key device may be worn on the user’s shirt, blouse, hat, helmet, or headband, for instance. In some scenarios, the key device may be concealed from view—e.g., carried in a pocket of the user’s clothing, placed in a wallet, or attached to a protective sleeve of the user’s portable phone. These and other key-device variants are all equally envisaged.

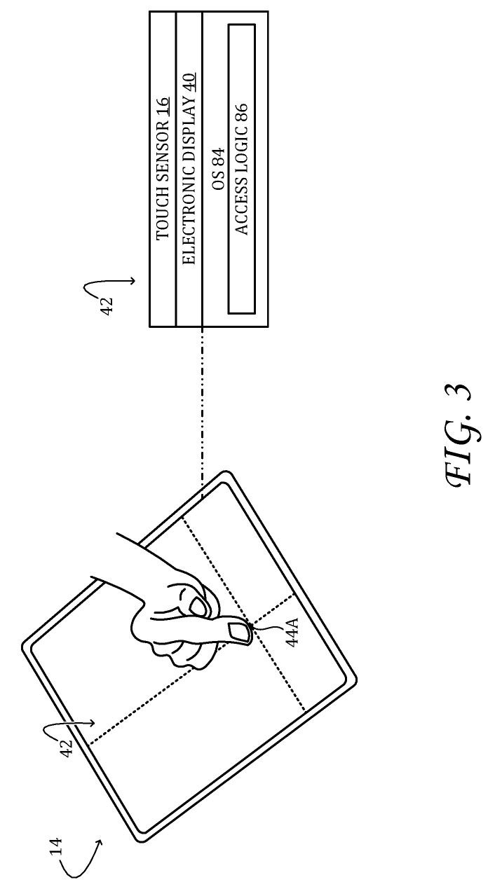

FIG. 2 shows aspects of an example key device 18. The illustrated key device includes a key-device transmitter 20, a key-device receiver 22, key-device logic 24, and a power supply 26. The key-device receiver includes an antenna that picks up in-bound signal and a demodulator that demodulates the in-bound signal and passes corresponding in-bound data to key-device logic 24. The key-device logic processes the in-bound data according to one or more pre-determined algorithms and generates out-bound data, which it provides to the key-device transmitter. The key-device transmitter includes a modulator that modulates the out-bound data, thereby forming a modulated out-bound signal, which it transmits via an antenna. The modulation frequencies of the in-bound and out-bound signals are not particularly limited. In some examples, the modulation frequencies may fall within the radio-frequency (RF) or microwave (MW) bands.

Power supply 26 provides suitable supply voltage to key-device transmitter 20, key-device receiver 22, and key-device logic 24. To that end, the power supply includes an electrically conductive loop 28 configured to absorb electromagnetic (EM) radiation passing thereby and to harvest energy, in the form of electric current, from the EM radiation absorbed. The power supply operates according to the principle of EM induction. In order to increase the voltage driving the electric current, the electrically conductive loop may be part of a longer, continuous path of plural (e.g., concentric), electrically conductive loops. In some examples, the path may span the thickness of key device 18, with adjacent turns of electrically conductive material separated by electrically insulating laminae. Power supply 26 may include a voltage converter 30 configured to convert the induced voltage to a form suitable for powering the electronic components of key device 18. The voltage converter may include a rectifier and a voltage multiplier, for instance. Though not strictly necessary, the power supply may also include a rechargeable chemical battery or supercapacitor 32, configured to store the absorbed energy until it is needed.

In examples in which power supply 26 includes a rechargeable chemical battery or supercapacitor, the energy input to electrically conductive loop 28 may be provided by virtually any EM radiator of a suitable emission wavelength—e.g., a wireless charging station of the kind used for handheld devices. When used in proximity to touch-screen system 14, however, such energy may be radiated by the driven electrodes 34 of the touch sensor thereof (vide infra). Furthermore, a touch-screen system configured to communicate with an active pen typically includes both a touch-sensor transmitter 36 and a touch-sensor receiver 38. The touch-sensor transmitter can be used to transmit in-bound signal to key device 18, and the touch-sensor receiver can be used to receive out-bound signal from the key device. In light of these advantages, the balance of this disclosure highlights implementations in which computer system 14 of FIG. 2 takes the form of a touch-screen system configured to communicate also with an active pen.

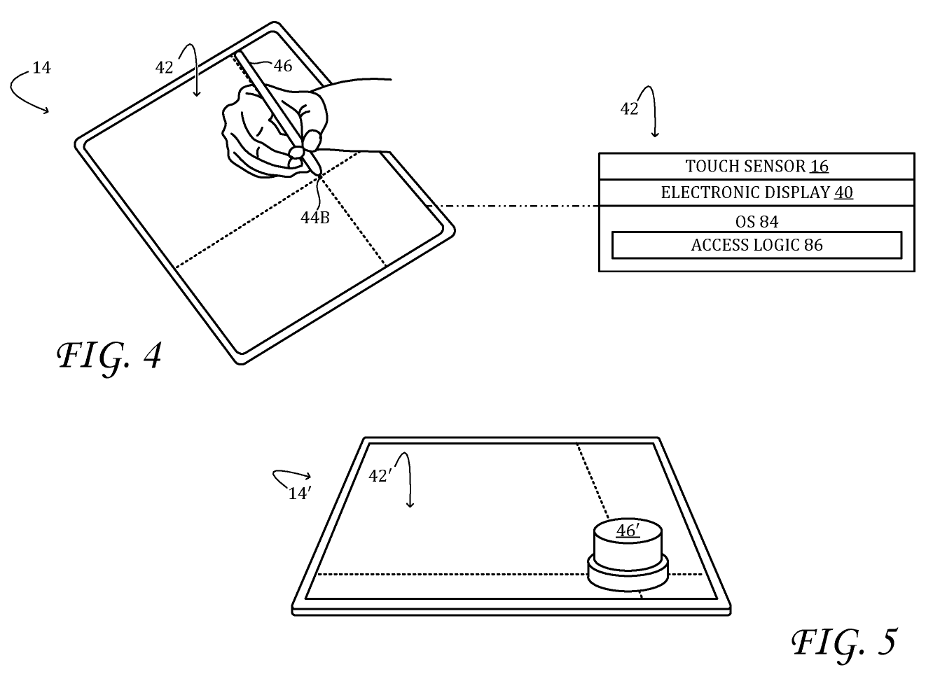

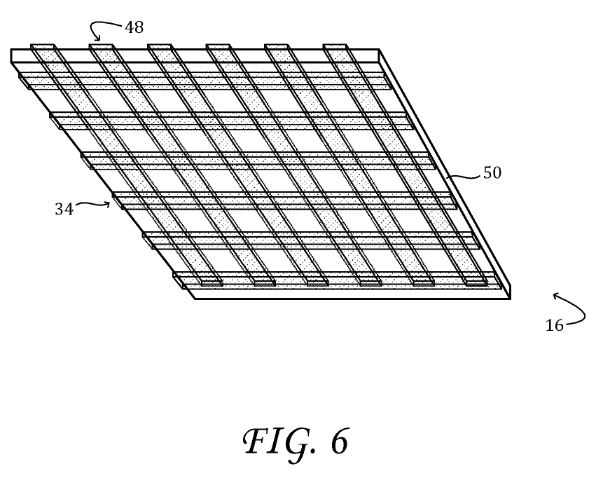

FIG. 3 shows aspects of an example touch-screen system 14 having an electronic display 40. In some examples, the electronic display is a liquid-crystal display (LCD). In some examples, the electronic display is a light-emitting diode (LED) display, such as active-matrix organic LED (AMOLED) or quantum LED (QLED) display. Electronic displays of other kinds are also envisaged. Touch-screen system 14 includes a capacitive touch sensor 16 having a front surface 42 atop the front surface of electronic display 40. The touch sensor is configured to acquire touch signal responsive to touch from the user’s finger or active pen on the front surface and thereby locate at least one touch point effected by the user. Touch point 44A is the point of contact between the user’s fingertip and front surface 42. Touch point 44B of FIG. 4 is the point of contact between active pen 46 and the front surface.

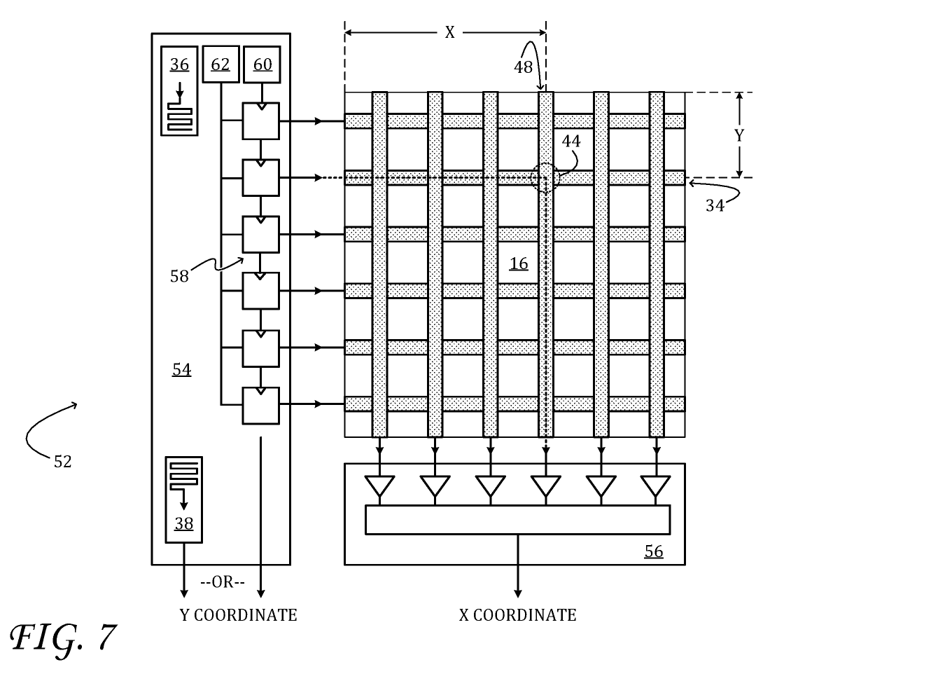

Turning ahead to FIG. 6, this drawing shows aspects of an example touch sensor 16 in expanded detail. The touch sensor comprises a series of row electrodes 34 that cross a series of column electrodes 48. Touch sensors here contemplated may include any number N of row electrodes and any number M of column electrodes, providing MN crossings or intersections. Although it is customary to have the row electrodes aligned horizontally and the column electrodes aligned vertically, that aspect is by no means necessary: the terms ‘row’ and ‘column’ can be exchanged everywhere in this disclosure. In the illustrated example the series of row electrodes 34 is arranged on one face of a dielectric layer 50, and the series of column electrodes 48 is arranged on the opposite face of the dielectric layer. The dielectric layer may be 50 to 100 μm in some examples, although other thickness ranges are also envisaged. The dielectric layer may comprise a polymer film, such as a polyethylene terephthalate (PET) film. In curved, flexible and/or bendable touch-screen systems, the dielectric layer may be curved, flexible and/or bendable.

Row electrodes 34 and column electrodes 48 each comprise electronically conductive material distributed in the form of narrow (e.g., 1-mm wide), elongate bands on the opposite faces of dielectric layer 50. Adjacent electrodes may be separated by one to five millimeters in some examples. The composition of electronically conductive material is not particularly limited. The electronically conductive material may comprise a metallic microwire mesh, a metal-particle or metal-island film, or a film of a degenerately doped semiconductor, such as indium-tin oxide (ITO), for instance. Irrespective of the implementation, a touch sensor comprising row and column electrodes of relatively low resistance and high optical transmittance is desirable.

Turning now to FIG. 7, row electrodes 34 and column electrodes 48 of touch sensor 16 are addressed by touch-sensor logic 52. The touch-sensor logic may take the form of one or more dedicated, integrated-circuits (ICs), typically including at least one low-power, firmware processor. The touch-sensor logic is configured to sense contact on or near the front surface of the touch sensor, including coordinates (X, Y) directly beneath a touch point 44. To that end, the touch-sensor logic includes row-drive circuit 54 and column-sense circuit 56. The terms ‘row-drive’ and ‘column-sense’ are intuitive for configurations in which drive signal is driven through the row electrodes and sensed via the column electrodes (vide supra). Based on that intuition, and with no geometric limitations implied, the terms ‘column signal’ and ‘touch signal’ are used interchangeably in this disclosure.

Column-sense circuit 56 is configured to sense a column signal from the series of column electrodes 48. In the illustrated example, the column-sense circuit includes M column amplifiers, each coupled to a corresponding column electrode. Row-drive circuit 54 includes a local row counter 58 in the form of an N-bit shift register with outputs driving each of N row electrodes 34. The local row counter is clocked by row-driver clock 60. The local row counter includes a blanking input to temporarily force all output values to zero irrespective of the values stored within the shift-register. Excitation of one or more rows may be provided by filling the local row counter with ones at every output to be excited, and zeroes elsewhere, and then toggling the blanking signal with the desired modulation from modulation clock 62. In the illustrated example, the output voltage may take on only two values, corresponding to the one or zero held in each bit of the local row counter. In other examples, the output voltage may take on a greater range of values, to alter the harmonic content of the output waveforms or increase or decrease radiated emissions, for instance. In some examples, row-drive circuit 54 may include one or more additional registers offset with respect to local row counter 58 and blanked by modulation clocks of different frequencies.

Row-drive circuit 54 of FIG. 7 applies an excitation pulse to each row electrode 34 in a pre-determined sequence. In this manner, the row-drive circuit is configured to drive one or more row electrodes of the series of row electrodes while leaving undriven one or more other row electrodes of the series of row electrodes. During a period in which the front surface is untouched, none of the column amplifiers registers an above-threshold output. The electrical impedance at each crossing of a row electrode 34 and a column electrode 48 is responsive, however, to the proximity of a finger or pen to that crossing: when the user places a fingertip on the front surface, the fingertip capacitively couples one or more row electrodes 34 proximate to touch point 44 to one or more column electrodes 48 also proximate to the touch point. The capacitive coupling induces the largest signal change on the column electrode directly behind the touch point and smaller changes on column electrodes to either side, which tail off with increasing distance from the touch point.

In some examples, column-sense circuit 56 returns, as the X coordinate of the touch point, the numeric value of the column providing the greatest signal received. Touch-sensor logic 52 determines which row was being excited when the greatest signal was received and returns the numeric value of that row as the Y coordinate of the touch point. In some examples, column-sense circuit 56 may also return a Z coordinate that varies in dependence on the strength of the signal at coordinates (X, Y). Accordingly, touch-sensor logic 52 may distinguish firm touch, associated with strong signal, from light touch, associated with weaker signal, and from hover, associated with still weaker but detectable signal. Alternatively or in addition, the touch-sensor logic may provide an output that varies according to the area of contact—e.g., the number of touched electrodes—which also may relate to the touch force.

In this manner, the series of driven row electrodes 34 of touch sensor 16 are usable for capacitive touch detection. These electrodes, when driven, radiate EM energy. Such energy is receivable by key device 18 of FIG. 2 and is suitable for powering the key device.

Returning briefly to FIG. 4, pen 46 may be used in lieu of the user’s fingertip to execute touch input on touch-screen system 14. Although it is typical for a pen to take the form of an elongate cylinder, that aspect is not strictly necessary. FIG. 5 shows an alternatively shaped pen 46′ usable on a large-format touch-screen system 14′. It will be noted that pens of various shapes and sizes are envisaged herein.

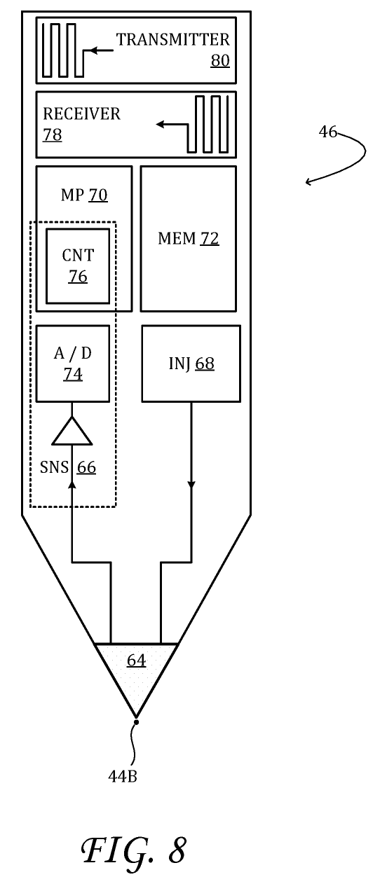

Relative to a passive (i.e., dielectric) pen, an active pen offers even greater touch accuracy, in addition to faster and more accurate tracking of the touch point. FIG. 8 shows aspects of an example active pen 46, in which probe electrode 64 is arranged at the pen tip. The probe electrode is coupled operatively to sensory logic 66 and to injection logic 68. The sensory logic may be embodied at least partly within microprocessor 70, which is configured for digital signal processing (DSP) and coupled operatively to computer memory 72. Sensory logic 66 includes linear analog componentry configured to maintain probe electrode 64 at a constant voltage and to convert any current into or out of the probe electrode into a proportional current-sense voltage. The sensory logic may include an analog-to-digital (A / D) converter 74 that converts the current-sense voltage into digital data to facilitate subsequent processing.

Instead of capacitively coupling row and column electrodes of the touch sensor via a dielectric, sensory logic 66 of active pen 46 may sense the arrival of an excitation pulse from a row electrode 34 behind touch point 44B, and in response, inject charge into column electrode 48 also behind the touch point. To that end, injection logic 68 is configured to control charge injection from the probe electrode 64 to the column electrode directly beneath the probe electrode. The injected charge may appear, to column-sense circuit 56, similar to an electrostatic pulse delivered via capacitive coupling of the column electrode to an energized row electrode intersecting at the touch point.

In some examples, sensory logic 66 and injection logic 68 are active during non-overlapping time windows of each touch-sensing frame, so that charge injection and charge sensing may be enacted at the same probe electrode 64. In this implementation, touch-sensor logic 52 excites the series of row electrodes 34 during the time window in which the sensory logic is active, but suspends row excitation during the time window in which active pen 46 may inject charge. This strategy provides an additional advantage, in that it enables touch-sensor logic 52 to distinguish touch points effected by the active pen from touch points effected by a fingertip or palm. If column-sense circuit 56 detects charge from a column electrode 48 during the charge-injection time window of active pen 46 (when none of the row electrodes 34 are excited), then touch point detected must be a touch point of the active pen.

Active sensing followed by charge injection enables a touch point 44B of a very small area to be located precisely, and without requiring long integration times that would increase the latency of touch sensing. Nevertheless, this approach introduces certain challenges related to noise suppression. Another solution is to require pen 46 to assume a more active role in determining the touch point coordinates. In the illustrated example, sensory logic 66 of active pen 46 includes a remote row counter 76, which is maintained in synchronization with local row counter 58 of touch-sensor logic 52. To that end (and returning briefly to FIG. 7), touch-sensor logic 54 includes a touch-sensor transmitter 36. The touch-sensor transmitter is configured to transmit a synchronization signal to active pen 46, which is received by pen receiver 78. This feature wirelessly provides shared timing between the active pen and the touch sensor (viz., between local row counter 58 and remote row counter 76). When probe electrode 64 touches the front surface of the touch sensor, sensory logic 66 receives a waveform that lasts as long as the touch is maintained. The waveform acquires maximum amplitude at the moment in time when the row electrode directly beneath the probe electrode has been energized. Sensory logic 68 is configured to sample the waveform at each increment of the remote row counter 76 and determine when the maximum amplitude is sensed. This determination can be made once per frame, for example.

Because active pen 46 and touch-sensor logic 52 have shared timing due to synchronized row counters, the state of remote row counter 76 at maximum sensed amplitude reports directly on the row coordinate—i.e., the Y coordinate—of touch point 44B. In order to make use of this information, the row coordinate must be communicated back to touch-sensor logic 52. To that end, the active pen includes a pen transmitter 80, and row-sense logic 54 includes a touch-sensor receiver 38. The pen transmitter is configured to communicate the computed row coordinate in modulated form to the row-sense logic, via the touch-sensor receiver 38. The touch-sensor receiver is configured to receive the modulated sensory signal from the pen transmitter and pass the demodulated row coordinate to touch-sensor logic 52.

Returning to FIG. 3, touch-screen system 14 includes an operating system (OS) 84 comprising various drivers and services. At least one of the OS services of the touch-screen system includes access logic 86, which is configured to control user access to the touch-screen system. In some examples, the access logic may include biometric access logic configured to enact biometric authentication of the user. The biometric access logic may be coupled operatively to various hardware drivers of the touch-screen system—e.g., camera and touch-input drivers for facial and fingerprint recognition, respectively.

In the configurations herein, access logic 86 is coupled operatively to touch-sensor receiver 38 and to touch-sensor transmitter 36, as shown in FIG. 2. The co-operativity is directed to user authentication and places additional demands on the touch-sensor receiver and on the touch-sensor transmitter. In particular, the touch-sensor receiver is configured to receive an uplink signal from a nearby key device 18, to extract corresponding uplink data from the uplink signal, and to present the uplink data to access logic 86. This use of the touch-screen receiver and touch-screen transmitter provides the technical effect of reducing the complexity and manufacturing cost of a user-authenticating touch-screen system—for these same components are present in virtually any touch-screen system configured to communicate with an active pen. In some examples, the uplink signal from the key device initiates a ‘handshake’ with the touch-screen system. The touch-screen system responds by issuing a challenge to the key device, which is suitable for authenticating the user associated with the key device. The access logic is configured to provide the challenge data in response to the uplink data. Touch-sensor transmitter 36 is configured to receive the challenge data from the access logic and to transmit corresponding challenge signal to the key device. The key device is configured to receive and demodulate the challenge signal, process the corresponding challenge data, and generate, modulate, and transmit an appropriate response in the form of a downlink signal. The touch-sensor receiver is further configured to receive the downlink signal from the key device and extract corresponding downlink data from the downlink signal, which it then provides to the access logic. Downlink data provided ultimately in response to uplink data from a separate key device makes the authentication desirably robust.

As described further below, access logic 86 may be configured to forbid a user from accessing touch-screen system 14 unless the downlink data authenticates the user and touch-sensor receiver 38 continues to receive signal of pre-determined signal strength from key device 18. In some examples, a user interface of the touch-screen system may be configured to provide visual or auditory feedback to the user, which reflects whether access is granted or denied. In particular, the access logic is configured to adjust the feedback based at least partly on whether the downlink data authenticates the user or the touch-sensor receiver continues to receive signal of pre-determined signal strength from the key device.

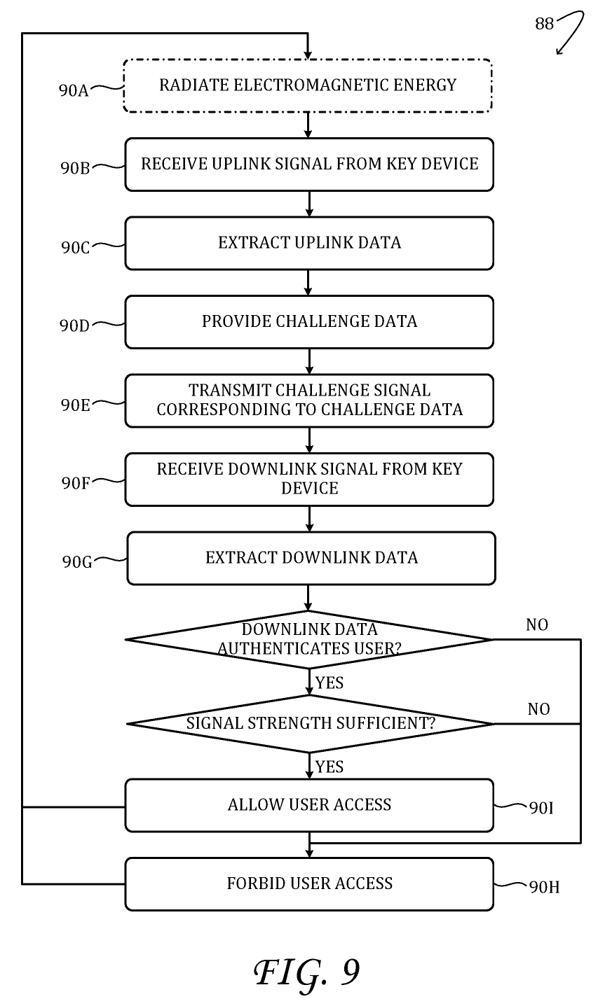

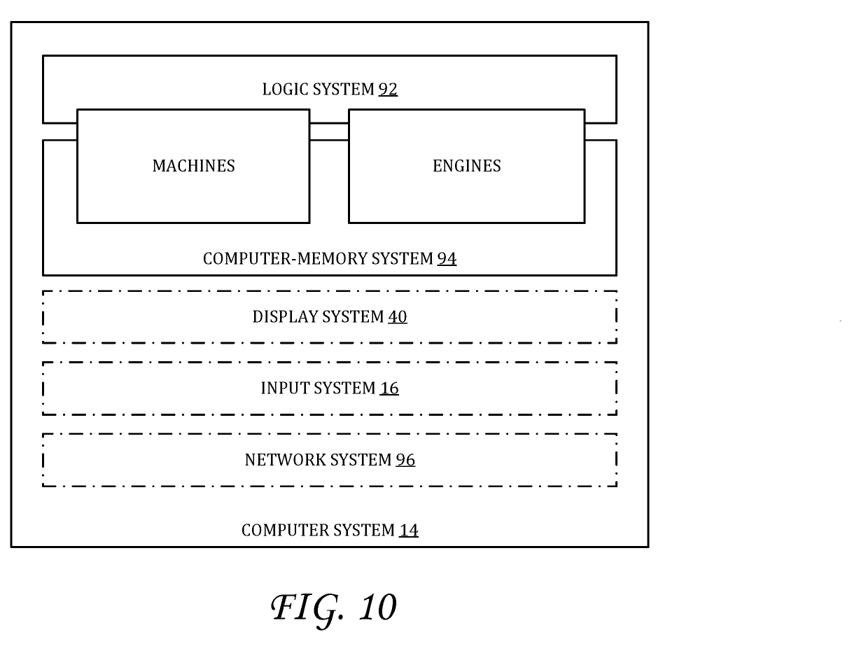

FIG. 9 shows aspects of an example method 88 for controlling user access to a touch-screen system. The method is enacted in an environment comprising, in addition to the touch-screen system, at least one user with a key device on his or her person. The key device provides the technical effect of authenticating the user on the touch-screen system, without requiring the user to enter a passcode; this feature enhances the usability of the touch-screen system.

At optional step 90A, the touch-screen system radiates EM energy receivable by the key device, such energy being suitable for powering the key device. In some examples, the EM energy is radiated from a series of driven electrodes usable for capacitive touch detection on the touch-screen system. The EM energy radiated by driven electrodes of the touch-screen system provides the technical effect of supplying wireless power to the key device, and without requiring a dedicated wireless charging station. Because the driven electrodes are present in virtually any touch-screen system and need not be modified in order to charge the key device, this feature reduces the complexity and manufacturing cost of a user-authenticating touch-screen system.

At 90B, a touch-sensor receiver of the touch-screen system receives an uplink signal from a key device. The uplink signal comprises handshake data that modulates a carrier wave. At 90C, the touch-sensor receiver presents to the access logic the demodulated uplink data corresponding to the uplink signal. The uplink data may take the form of any suitable protocol for initiating a wireless handshake between digital devices. In some examples, handshake data may conform to a recognized protocol, such as a transport-layer security (TLS) protocol.

At 90D, access logic of the touch-screen system provides challenge data in response to the uplink data. The challenge data may be configured so as to define a problem that the key device must solve in order to gain access to the touch-screen system. In one, non-limiting example, the challenge data may define a very long integer having two or more factors, wherein solving the challenge amounts to returning the two or more factors. At 90E, the touch-screen system transmits to the key device a challenge signal corresponding to the challenge data. Generation of the challenge data, transmission of the corresponding challenge signal to the key device, and subsequent steps of receiving and decoding the downlink response (vide infra) provides the technical effect of securing the touch-screen system against unauthorized user access. In some examples, the challenge signal is used to modulate a carrier wave; the modulated carrier wave is then transmitted by a touch-sensor transmitter. As described hereinabove, the touch-sensor transmitter is the same transmitter configured to transmit a synchronization signal to an active pen.

At 90F, the touch-sensor receiver of the touch-screen system receives a downlink signal from the key device. The downlink signal may comprise a carrier wave which is modulated by downlink data formulated by the key device in response to the challenge data. For instance, the downlink data may comprise the two or more factors of the very long integer noted above. At 90G, the touch-sensor receiver presents downlink data corresponding to the downlink signal to the access logic. In some examples, the uplink and downlink signals are received, and the corresponding data presented, by a touch-sensor receiver also configured to receive sensory signal from an active pen.

At this point in method 88, the access logic, now in possession of the downlink data, is equipped to determine whether the key device has or has not successfully authenticated a user of the touch-screen system. For instance, in the non-limiting example used above, the access logic may determine whether the factors received in the downlink data yield the very long integer presented in the challenge data.

In addition, the access logic may monitor the strength of the downlink signal to ensure that it remains above a pre-determined signal strength. This aspect of method 88 addresses the issue noted above, wherein an authenticated user (with the key device still on his or her person) walks away from the touch-screen system while still logged in to the touch-screen system, potential exposing the system to non-authenticated access by another. Thus, the signal-strength assessment provides the technical effect of further securing the touch-screen system against unauthorized user access. In method 88, the departure of the authenticated user from the locus of the touch-screen system causes the signal strength to decrease in proportion to the square of the separation distance. Accordingly, the signal strength falling below a pre-determined threshold may be used as a surrogate for the key device being ‘out of range’ of the touch-screen system.

At 90H, accordingly, the access logic of the touch-screen system forbids the user from accessing the touch-screen system unless the downlink data authenticates the user and signal of pre-determined signal strength continues to be received from the key device. In some examples, the pre-determined signal strength may be adjusted based at least partly on the preference of an authenticated user or administrator, and/or based at least partly on the operating environment of the touch-screen system. This feature provides the technical effect of ease of instantiation of the generic method to different scenarios and environments, which makes the method extensible to different environments and scenarios.

In a scenario in which the user is already authenticated, user-access forbiddance at 90H may be a discrete event in which the touch-screen system suddenly de-authenticates the user. In some examples, the touch-screen system or a function thereof may become locked. In some examples, security measures, such as a requirement of a passcode login, may be triggered. In a scenario in which the user is not already authenticated, user-access forbiddance at 90H may comprise maintaining the current authentication state of the user. If user access is not forbidden then it may be allowed, at 90I of method 88. In a scenario in which the user is not already authenticated, user-access allowance at 90I may be a discrete event comparable to acceptance of a passcode login by the touch-screen system; in a scenario in which the user is already authenticated, user-access allowance at 90I may comprise maintaining the current authentication state of the user—e.g., keeping the touch-screen system or one or more functions of the touch-screen system unlocked.

It will be noted that the above logic neither requires nor excludes additional authentication tests, such as multi-factor authentication and/or biometric authentication. In some examples, accordingly, the access logic of the touch-screen system may enact multi-factor and/or biometric authentication of the user and may forbid the user from accessing the touch-screen system upon failure of the multi-factor and/or biometric authentication. Suitable biometric authentication may comprise facial recognition, fingerprint recognition, etc. Individually or in combination, multi-factor and biometric authentication each provide the technical effect of safeguarding user authentication from the efforts of malicious actors who may seek access to the touch-screen system.

No aspect of the foregoing drawings or description should be understood in a limiting sense because numerous variations, extensions, and omissions are also envisaged. Although the access logic described above may be configured to control any access to the touch-screen system, this disclosure is equally consonant with variants in which the access logic controls user access to at least one particular function of the touch-screen system. Example functions include logging onto websites, accessing secure domains, and making contactless payments. In particular, the access logic may forbid the user from accessing the function unless the downlink data authenticates the user with respect to the function and the touch-sensor receiver continues to receive signal of pre-determined signal strength from the key device. In a scenario in which one or more relatively sensitive functions are forbidden, access to one or more less sensitive functions may be allowed. This feature provides the technical effect of enhancing the usability of the touch-screen system, by enforcing user-authentication protections only on those functions determined to require protection. For instance, less sensitive functions of the touch-screen system may continue to operate even when the key device is out of range.

In some examples, the touch-screen system may provide visual or auditory feedback to the user on a user interface of the touch-screen system. Optionally, the feedback may be adjusted based at least partly on whether the downlink data authenticates the user or the touch-sensor receiver continues to receive signal of pre-determined signal strength from the key device. This feature provides the technical effect of improving the usability of the touch-screen system. For instance, in the event that user authentication has failed, the user interface may alert the user to that fact. Optionally, the user interface may alert the user to the reason for the authentication failure—inappropriate uplink data or key device out of range, for instance.

FIG. 10 schematically shows a non-limiting embodiment of a computer system 14 that can enact one or more of the methods and processes described above. Computer system 14 is shown in simplified form. Components of the computer system 14 may be instantiated in one or more personal computers, server computers, network computing devices, and/or other computing devices.

Computer system 14 includes a logic system 92 and a computer-memory system 94. Computer system 14 may optionally include a display system 40, an input system 16, a network system 96, and/or other systems not shown in the drawings.

Logic system 92 includes one or more physical devices configured to execute instructions. For example, the logic system may be configured to execute instructions that are part of at least one operating system (OS), application, service, and/or other program construct. The logic system may include at least one hardware processor (e.g., microprocessor, central processor, central processing unit (CPU) and/or graphics processing unit (GPU)) configured to execute software instructions. Additionally or alternatively, the logic system may include at least one hardware or firmware device configured to execute hardware or firmware instructions. A processor of the logic system may be single-core or multi-core, and the instructions executed thereon may be configured for sequential, parallel, and/or distributed processing. Individual components of the logic system optionally may be distributed among two or more separate devices, which may be remotely located and/or configured for coordinated processing. Aspects of the logic system may be virtualized and executed by remotely-accessible, networked computing devices configured in a cloud-computing configuration.

Computer-memory system 94 includes at least one physical device configured to temporarily and/or permanently hold computer system information, such as data and instructions executable by logic system 92. When the computer-memory system includes two or more devices, the devices may be collocated or remotely located. Computer-memory system 94 may include at least one volatile, nonvolatile, dynamic, static, read/write, read-only, random-access, sequential-access, location-read addressable, file-read addressable, and/or content-read addressable computer-memory device. Computer-memory system 94 may include at least one removable and/or built-in computer-memory device. When the logic system executes instructions, the state of computer-memory system 94 may be transformed—e.g., to hold different data.

Aspects of logic system 92 and computer-memory system 94 may be integrated together into one or more hardware-logic components. Any such hardware-logic component may include at least one program- or application-specific integrated circuit (PASIC / ASIC), program- or application-specific standard product (PSSP / ASSP), system-on-a-chip (SOC), or complex programmable logic device (CPLD), for example.

Logic system 92 and computer-memory system 94 may cooperate to instantiate one or more logic machines or engines. As used herein, the terms ‘machine’ and ‘engine’ each refer collectively to a combination of cooperating hardware, firmware, software, instructions, and/or any other components that provide computer system functionality. In other words, machines and engines are never abstract ideas and always have a tangible form. A machine or engine may be instantiated by a single computing device, or a machine or engine may include two or more subcomponents instantiated by two or more different computing devices. In some implementations, a machine or engine includes a local component (e.g., a software application executed by a computer system processor) cooperating with a remote component (e.g., a cloud computing service provided by a network of one or more server computer systems). The software and/or other instructions that give a particular machine or engine its functionality may optionally be saved as one or more unexecuted modules on one or more computer-memory devices.

Machines and engines (as used throughout the above description) may be implemented using any suitable combination of machine learning (ML) and artificial intelligence (AI) techniques. Non-limiting examples of techniques that may be incorporated in an implementation of one or more machines include support vector machines, multi-layer neural networks, convolutional neural networks (e.g., spatial convolutional networks for processing images and/or video, and/or any other suitable convolutional neural network configured to convolve and pool features across one or more temporal and/or spatial dimensions), recurrent neural networks (e.g., long short-term memory networks), associative memories (e.g., lookup tables, hash tables, bloom filters, neural Turing machines and/or neural random-access memory) unsupervised spatial and/or clustering methods (e.g., nearest neighbor algorithms, topological data analysis, and/or k-means clustering), and/or graphical models (e.g., (hidden) Markov models, Markov random fields, (hidden) conditional random fields, and/or AI knowledge bases)).

When included, display system 40 may be used to present a visual representation of data held by computer-memory system 94. The visual representation may take the form of a graphical user interface (GUI) in some examples. The display system may include one or more display devices utilizing virtually any type of technology. In some implementations, the display system may include one or more virtual-, augmented-, or mixed reality displays.

When included, input system 16 may comprise or interface with one or more input devices. An input device may include a sensor device or a user input device. Examples of user input devices include a keyboard, mouse, or touch screen.

When included, network system 96 may be configured to communicatively couple computer system 14 with one or more other computer systems. The network system may include wired and/or wireless communication devices compatible with one or more different communication protocols. The network system may be configured for communication via personal-, local- and/or wide-area networks.

To further summarize, one aspect of this disclosure is directed to a touch-screen system comprising access logic, a touch-sensor receiver, and a touch-sensor transmitter. The access logic is configured to control user access to the touch-screen system. The touch-sensor receiver is configured to: (a) receive a modulated sensory signal from an active pen, (b) receive an uplink signal from a key device and extract corresponding uplink data from the uplink signal, and (c) receive a downlink signal from the key device and extract corresponding downlink data from the downlink signal. The touch-sensor transmitter is configured to: (d) transmit a synchronization signal to the active pen, and (e) receive challenge data from the access logic and transmit corresponding challenge signal to the key device, wherein the access logic is configured to provide the challenge data in response to the uplink data. The access logic is further configured to forbid a user from accessing the touch-screen system unless the downlink data authenticates the user and the touch-sensor receiver continues to receive signal of pre-determined signal strength from the key device.

In some implementations the touch-screen system further comprises a series of driven electrodes usable for capacitive touch detection, wherein the series of driven electrodes is configured to radiate electromagnetic energy receivable by the key device, which is suitable for powering the key device. In some implementations the access logic supports biometric authentication of the user and is further configured to forbid the user from accessing the touch-screen system upon failure of the biometric authentication. In some implementations the access logic supports multi-factor authentication of the user and is further configured to forbid the user from accessing the touch-screen system upon failure of the multi-factor authentication. In some implementations the pre-determined signal strength is adjustable. In some implementations the access logic is further configured to control user access to a function of the touch-screen system and to forbid a user from accessing the function unless the downlink data authenticates the user with respect to the function and the touch-sensor receiver continues to receive signal of pre-determined signal strength from the key device. In some implementations the touch-screen system further comprises a user interface configured to provide visual or auditory feedback to the user, and the access logic is further configured to adjust the feedback based at least partly on whether the downlink data authenticates the user or the touch-sensor receiver continues to receive signal of pre-determined signal strength from the key device.

Another aspect of this disclosure is directed to a method for controlling user access to a touch-screen system. The method comprises: (a) receiving an uplink signal from a key device and extracting corresponding uplink data from the uplink signal; (b) providing challenge data in response to the uplink data and transmitting a corresponding challenge signal to the key device, wherein the challenge signal is transmitted by a touch-sensor transmitter also configured to transmit a synchronization signal to an active pen; (c) receiving a downlink signal from the key device and extracting corresponding downlink data from the downlink signal, wherein the uplink and downlink signals are received by a touch-sensor receiver also configured to receive sensory signal from the active pen; and (d) forbidding a user from accessing the touch-screen system unless the downlink data authenticates the user and signal of pre-determined signal strength continues to be received from the key device.

In some implementations the challenge data is configured to define a problem that the key device must solve in order for the user to gain access to the touch-screen system. In some implementations the method further comprises radiating electromagnetic energy receivable by the key device, which is suitable for powering the key device, wherein the electromagnetic energy is radiated from a series of driven electrodes usable for capacitive touch detection. In some implementations the method further comprises enacting biometric authentication of the user and forbidding the user from accessing the touch-screen system upon failure of the biometric authentication. In some implementations the method further comprises adjusting the pre-determined signal strength. In some implementations the method further comprises controlling user access to a function of the touch-screen system including forbidding a user from accessing the function unless the downlink data authenticates the user with respect to the function and the touch-sensor receiver continues to receive signal of pre-determined signal strength from the key device. In some implementations the function is a first function, and wherein access to a second function less sensitive than the first, is allowed when the access to the first function is forbidden. In some implementations the method further comprises providing visual or auditory feedback to the user on a user interface of the touch-screen system, including adjusting the feedback based at least partly on whether the downlink data authenticates the user or the touch-sensor receiver continues to receive signal of pre-determined signal strength from the key device. In some implementations forbidding the user from accessing the touch-screen system comprises locking the touch-screen system. In some implementations forbidding the user from accessing the touch-screen system comprises maintaining an authentication state of the user if access by the user is not already allowed. In some implementations the method further comprises allowing the user to access the touch-screen system provided that the downlink data authenticates the user and that signal of pre-determined signal strength is received from the key device, wherein allowing the user to access the touch-screen system comprises maintaining a current authentication state of the user provided that access by the user is already allowed.

Another aspect of this disclosure is directed to a touch-screen system comprising access logic, a touch-sensor receiver, a touch-sensor transmitter, and a series of driven electrodes. The access logic is configured to control user access to the touch-screen system. The touch-sensor receiver is configured to: (a) receive a modulated sensory signal from an active pen, (b) receive an uplink signal from a key device and extract corresponding uplink data from the uplink signal, and (c) receive a downlink signal from the key device and extract corresponding downlink data from the downlink signal. The touch-sensor transmitter is configured to: (d) transmit a synchronization signal to the active pen, and (e) receive challenge data from the access logic and transmit corresponding challenge signal to the key device, wherein the access logic is configured to provide the challenge data in response to the uplink data. Usable for capacitive touch detection, the series of driven electrodes is configured to radiate electromagnetic energy receivable by the key device, which is suitable for powering the key device. The access logic is further configured to forbid a user from accessing the touch-screen system unless the downlink data authenticates the user and the touch-sensor receiver continues to receive signal of pre-determined signal strength from the key device.

In some implementations the access logic is further configured to control user access to at least one function of the touch-screen system and to forbid a user from accessing the at least one function unless the downlink data authenticates the user with respect to the at least one function and the touch-sensor receiver continues to receive signal of pre-determined signal strength from the key device.

This disclosure is presented by way of example and with reference to the attached drawing figures. Components, process steps, and other elements that may be substantially the same in one or more of the figures are identified coordinately and described with minimal repetition. It will be noted, however, that elements identified coordinately may also differ to some degree. It will be further noted that the figures are schematic and generally not drawn to scale. Rather, the various drawing scales, aspect ratios, and numbers of components shown in the figures may be purposely distorted to make certain features or relationships easier to see.

It will be understood that the configurations and/or approaches described herein are exemplary and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed. In that spirit, the phrase ‘based at least partly on’ is intended to remind the reader that the functional and/or conditional logic illustrated herein neither requires nor excludes suitable additional logic, executing in combination with the illustrated logic, to provide additional benefits.

The subject matter of the present disclosure includes all novel and non-obvious combinations and sub-combinations of the various processes, systems and configurations, and other features, functions, acts, and/or properties disclosed herein, as well as any and all equivalents thereof.

1. A touch-screen system comprising:
access logic configured to control user access to the touch-screen system;
a touch-sensor receiver configured to:
receive a modulated sensory signal from an active pen,
receive an uplink signal from a key device and extract corresponding uplink data from the uplink signal, and
receive a downlink signal from the key device and extract corresponding downlink data from the downlink signal;
a touch-sensor transmitter configured to:
transmit a synchronization signal to the active pen,
receive challenge data from the access logic and transmit corresponding challenge signal to the key device, wherein the access logic is configured to provide the challenge data in response to the uplink data; and
wherein the access logic is further configured to forbid a user from accessing the touch-screen system unless the downlink data authenticates the user and the touch-sensor receiver continues to receive signal of pre-determined signal strength from the key device.

2. The touch-screen system of claim 1, further comprising a series of driven electrodes usable for capacitive touch detection, wherein the series of driven electrodes is configured to radiate electromagnetic energy receivable by the key device, which is suitable for powering the key device.

3. The touch-screen system of claim 1, wherein the access logic supports biometric authentication of the user and is further configured to forbid the user from accessing the touch-screen system upon failure of the biometric authentication.

4. The touch-screen system of claim 1, wherein the access logic supports multi-factor authentication of the user and is further configured to forbid the user from accessing the touch-screen system upon failure of the multi-factor authentication.

5. The touch-screen system of claim 1, wherein the pre-determined signal strength is adjustable.

6. The touch-screen system of claim 1, wherein the access logic is further configured to control user access to a function of the touch-screen system and to forbid a user from accessing the function unless the downlink data authenticates the user with respect to the function and the touch-sensor receiver continues to receive signal of pre-determined signal strength from the key device.

7. The touch-screen system of claim 1, further comprising a user interface configured to provide visual or auditory feedback to the user, wherein the access logic is further configured to adjust the feedback based at least partly on whether the downlink data authenticates the user or the touch-sensor receiver continues to receive signal of pre-determined signal strength from the key device.

8. A method for controlling user access to a touch-screen system, the method comprising:
receiving an uplink signal from a key device and extracting corresponding uplink data from the uplink signal;
providing challenge data in response to the uplink data and transmitting a corresponding challenge signal to the key device, wherein the challenge signal is transmitted by a touch-sensor transmitter also configured to transmit a synchronization signal to an active pen;
receiving a downlink signal from the key device and extracting corresponding downlink data from the downlink signal, wherein the uplink and downlink signals are received by a touch-sensor receiver also configured to receive sensory signal from the active pen; and
forbidding a user from accessing the touch-screen system unless the downlink data authenticates the user and signal of pre-determined signal strength continues to be received from the key device.

9. The method of claim 8, wherein the challenge data is configured to define a problem that the key device must solve in order for the user to gain access to the touch-screen system.

10. The method of claim 8, further comprising radiating electromagnetic energy receivable by the key device, which is suitable for powering the key device, wherein the electromagnetic energy is radiated from a series of driven electrodes usable for capacitive touch detection.

11. The method of claim 8, further comprising enacting biometric authentication of the user and forbidding the user from accessing the touch-screen system upon failure of the biometric authentication.

12. The method of claim 8, further comprising adjusting the pre-determined signal strength.

13. The method of claim 8, further comprising controlling user access to a function of the touch-screen system including forbidding a user from accessing the function unless the downlink data authenticates the user with respect to the function and the touch-sensor receiver continues to receive signal of pre-determined signal strength from the key device.

14. The method of claim 13, wherein the function is a first function, and wherein access to a second function less sensitive than the first, is allowed when the access to the first function is forbidden.

15. The method of claim 8, further comprising providing visual or auditory feedback to the user on a user interface of the touch-screen system, including adjusting the feedback based at least partly on whether the downlink data authenticates the user or the touch-sensor receiver continues to receive signal of pre-determined signal strength from the key device.

16. The method of claim 8, wherein forbidding the user from accessing the touch-screen system comprises locking the touch-screen system.

17. The method of claim 8, wherein forbidding the user from accessing the touch-screen system comprises maintaining an authentication state of the user if access by the user is not already allowed.

18. The method of claim 8, further comprising allowing the user to access the touch-screen system provided that the downlink data authenticates the user and that signal of pre-determined signal strength is received from the key device, and wherein allowing the user to access the touch-screen system comprises maintaining a current authentication state of the user provided that access by the user is already allowed.

19. A touch-screen system comprising:
access logic configured to control user access to the touch-screen system;
a touch-sensor receiver configured to:
receive a modulated sensory signal from an active pen,
receive an uplink signal from a key device and extract corresponding uplink data from the uplink signal, and
receive a downlink signal from the key device and extract corresponding downlink data from the downlink signal;
a touch-sensor transmitter configured to:
transmit a synchronization signal to the active pen,
receive challenge data from the access logic and transmit corresponding challenge signal to the key device, wherein the access logic is configured to provide the challenge data in response to the uplink data; and
a series of driven electrodes usable for capacitive touch detection, wherein the series of driven electrodes is configured to radiate electromagnetic energy receivable by the key device, which is suitable for powering the key device,
wherein the access logic is further configured to forbid a user from accessing the touch-screen system unless the downlink data authenticates the user and the touch-sensor receiver continues to receive signal of pre-determined signal strength from the key device.

20. The touch-screen system of claim 19, wherein the access logic is further configured to control user access to at least one function of the touch-screen system and to forbid a user from accessing the at least one function unless the downlink data authenticates the user with respect to the at least one function and the touch-sensor receiver continues to receive signal of pre-determined signal strength from the key device.
